(19) United States
(12) Patent Application Publication
(10) Pub. No.: US 2003/0111647 A1
(43) Pub. Date: Jun. 19, 2003

(54) Electrically conductive polymeric composites

(75) Inventor: Nachum Rosenzweig, Kfar Vradim (IL)

Correspondence Address: DARBY & DARBY P.C., 805 Third Avenue, New York, NY, 10022, US

(73) Assignee: KAFRIT INDUSTRIES (1993) LTD.

(21) Appl. No.: 10/024,124

(22) Filed: Dec. 17, 2001

(51) Int. Cl. H01B 1/00

(52) U.S. Cl. 252/500; 252/512

(57) ABSTRACT

A conductive plastic article including a plastic material, a multiplicity of metal fibers disposed in the plastic material, the fibers being formed from a first metal having a first melting temperature and globules of a second metal having a second melting temperature, lower than the first melting temperature, conductively at least partially joining the fibers within the plastic material thus creating an electrically conductive network within the plastic.

### FIELD OF THE INVENTION

The present invention relates to conductive plastic materials generally and to methods and apparatus for producing such materials.

### BACKGROUND OF THE INVENTION

It is known to make conductive plastic materials from fibers of stainless steel. U.S. Pat. No. 4,500,595 is believed to represent the current state of the art.

### SUMMARY OF THE INVENTION

The present invention seeks to provide improved conductive plastic materials as well as methods and apparatus for producing such materials.

There is thus provided in accordance with a preferred embodiment of the present invention a conductive plastic article including a plastic material, a multiplicity of metal fibers disposed in the plastic material, the fibers being formed from a first metal having a first melting temperature and globules of a second metal having a second melting temperature, lower than the first melting temperature. The globules at least partially conductively join the fibers within the plastic material, thus creating an electrically conductive network within the plastic.

There is also provided in accordance with a preferred embodiment of the present invention a method for producing a conductive plastic article, which includes the steps of.

providing a multiplicity of fibers of a first metal having a first melting point,

forming a solid mass of the multiplicity of fibers of the first metal together with a second metal having a second melting point less than the first melting point,

combining plastic material with the solid mass,

heating the plastic material with the solid mass to a temperature above the second melting point but less than the first melting point, whereby the multiplicity of fibers are at least partially released from the solid mass and are at least partially conductively joined together by the second metal,

forming the conductive plastic article from the heated plastic material and

cooling the conductive plastic article wherein when cooled, the multiplicity of fibers are conductively joined at least partially by the second metal.

There is also provided in accordance with a preferred embodiment of the present invention an apparatus for producing a conductive plastic article. The apparatus includes a solid mass former receiving a multiplicity of fibers of a first metal having a first melting point and forming a solid mass of the multiplicity of fibers of the first metal together with a second metal having a second melting point less than the first melting point, a mixer combining plastic material with the solid mass, a heater heating the plastic material with the solid mass to a temperature above the second melting point but less than the first melting point, whereby the multiplicity of fibers are at least partially released from the solid mass and are conductively joined together by the second metal, and an article former forming the conductive plastic article from the heated plastic material and cooling the conductive plastic article wherein when cooled, the multiplicity of fibers are conductively joined at least partially by the second metal.

There is further provided in accordance with yet another preferred embodiment of the present invention a conductive article, which includes a multiplicity of metal fibers, the fibers being formed from a first metal having a first melting temperature and globules of a second metal having a second melting temperature, lower than the first melting temperature. The globules conductively at least partially joining the fibers thus creating an electrically conductive network.

Further in accordance with a preferred embodiment of the present invention, the first metal is selected from stainless steel alloys, such as type AISI 302, type AISI 306L and/or type AISI 347.

Still further in accordance with a preferred embodiment of the present invention, the second metal includes at least tin and a tin alloy.

Additionally in accordance with a preferred embodiment of the present invention, the first melting temperature is in the range of 400 to 3400° C. and the second melting temperature is in the range of 60 to 500° C. or in the range of 80 to 420° C.

Further in accordance with a preferred embodiment of the present invention, the plastic material includes a plastic material having a processing temperature which lies between the first melting temperature and the second melting temperature.

Preferably, the article is an injection-molded article.

Further in accordance with a preferred embodiment of the present invention, the article is an extruded article.

### BRIEF DESCRIPTION OF THE DRAWINGS

The present invention will be understood and appreciated more fully from the following detailed description, taken in conjunction with the drawings in which:

FIGS. 1 and 2 are simplified pictorial illustrations showing a conductive plastic material as well as a method and apparatus for producing same in accordance with a preferred embodiment of the present invention.

### DETAILED DESCRIPTION OF A PREFERRED EMBODIMENT

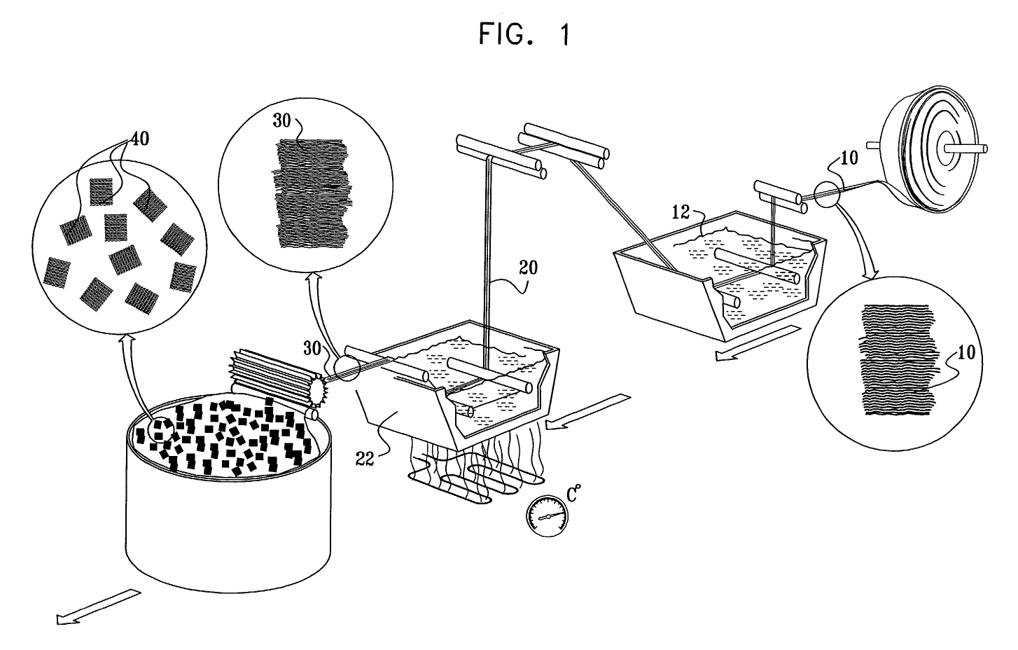

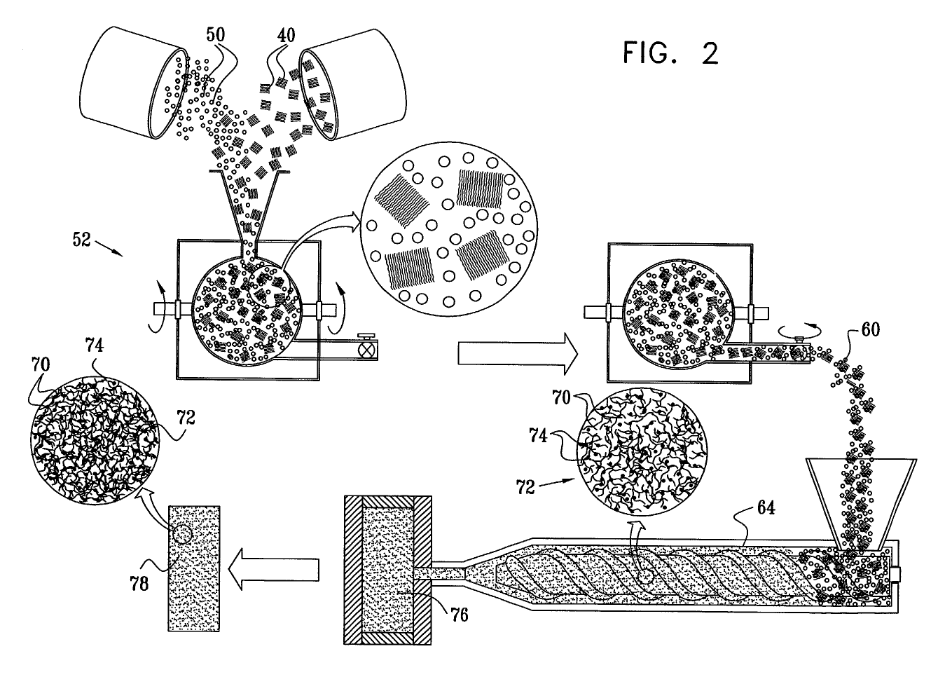

Reference is now made to FIGS. 1 and 2, which together illustrate a conductive plastic material as well as a method and apparatus for producing same, all in accordance with a preferred embodiment of the present invention.

As seen in FIGS. 1, a tow 10 or other multiplicity of fibers of a first metal having a first melting temperature, typically stainless steel is provided, each fiber preferably being of diameter 8 to 11 microns, commercially available from Bekaert Fibre Technologies of Zwevegem, Belgium, under the brand name BekiShield. Preferably, the first metal is selected from a set of stainless steel alloys consisting of: type AISI 302; type AISI 306L; and type AISI 347. Preferably, the first melting temperature is in the range of 400 to 3400° C.

The fibers of the first metal are passed through a bath 12 wherein they are surface treated to enhance the adhesion thereto of a second metal, having a second melting temperature lower than the first melting temperature, typically tin or a tin alloy. Preferably, the second melting temperature is in the range of 60 to 500° C. and more preferably in the range of 80 to 420° C.

The surface treatment in bath 12 typically comprises an acidic base, preferably halide activated acidic stainless steel flux, manufactured by AIM Solder, Israel. The surface treated tow, designated by reference numeral 20, is then dipped into a bath 22 of the second metal, typically in molten form or in electro- or electroless chemical solution, wherein it is impregnated by the second metal. Upon leaving the bath 22, the second metal cools and solidifies, thus turning the fiber tow 10 into a solid, rod like mass 30 of the first metal fibers, each coated with the second metal.

The mass 30 is then cut or otherwise separated into relatively small granules 40, each containing a multiplicity of fibers of the first metal, bonded together by the second metal. Typical dimensions of the granules 40 are 3 to 6 mm.

Turning now to FIG. 2, it is seen that preferably, granules 50 of a plastic material, preferably a plastic material having a processing temperature which lies between the first melting temperature and the second melting temperature, such as, for example a polycarbonate/ABS alloy, preferably CYCOLOY, commercially available from GE Plastics, are mixed together with granules of fibers 40 in a mixer 52. The resulting mixture 60 is preferably supplied to an extruder 64 or other plastic forming device, such as an injection molding device or a blow molding device which heats the mixture 60 to a temperature less than the melting temperature of the first metal but greater than the melting temperature of the second metal. This allows the individual fibers, here designated by reference numeral 70, in granules 40, to separate from each other in the plastic material, here designated by reference numeral 72, and to assume random positions relative to each other. The second metal defines globules 74, which join various fibers 70 in a somewhat fluid matrix 76. Globules 74 need not be round or rounded but may have any shape. This matrix 76 may then be molded as desired or delivered in pelletized form.

When the matrix 76 is cooled, a suitably molded article 78 is provided which includes in addition to the plastic material 72, a multiplicity of fibers 70, which are conductively interconnected by either contacting each other or by solidified globules 74 of the second metal.

It is a particular feature of the present invention that the provision of the second metal provides enhanced conductivity, as compared with prior art conductive plastic materials including metal fibers.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

1. A conductive plastic article comprising:
a plastic material;
a multiplicity of metal fibers disposed in said plastic material, said fibers being formed from a first metal having a first melting temperature; and
globules of a second metal having a second melting temperature, lower than said first melting temperature, conductively at least partially joining said fibers within said plastic material thus creating an electrically conductive network within said plastic.

2. A conductive plastic article according to claim 1 and wherein said first metal is selected from a set of stainless steel alloys consisting of: type AISI 302; type AISI 306L; and type AISI 347.

3. A conductive plastic article according to claim 1 and wherein said second metal comprises at least one of tin and a tin alloy.

4. A conductive plastic article according to claim 2 and wherein said second metal comprises at least one of tin and a tin alloy.

5. A conductive plastic article according to claim 1 and wherein said first melting temperature is in the range of 400 to 3400° C.

6. A conductive plastic article according to claim 1 and wherein said second melting temperature is in the range of 60 to 500° C.

7. A conductive plastic article according to claim 2 and wherein said second melting temperature is in the range of 80 to 420° C.

8. A conductive plastic article according to claim 1 and wherein said plastic material comprises a plastic material having a processing temperature which lies between said first melting temperature and said second melting temperature.

9. A conductive plastic article according to claim 1 and wherein said article is an injection-molded article.

10. A conductive plastic article according to claim 2 and wherein said article is an injection-molded article.

11. A method for producing a conductive plastic article comprising the steps of:
providing a multiplicity of fibers of a first metal having a first melting point;
forming a solid mass of said multiplicity of fibers of said first metal together with a second metal having a second melting point less than said first melting point;
combining plastic material with said solid mass;
heating said plastic material with said solid mass to a temperature above said second melting point but less than said first melting point, whereby said multiplicity of fibers are at least partially released from said solid mass and are at least partially conductively joined together by said second metal;
forming said conductive plastic article from said heated plastic material; and
cooling said conductive plastic article wherein when cooled, said multiplicity of fibers are conductively joined at least partially by said second metal.

12. A method according to claim 11 and wherein said first metal comprises AISI 302 stainless steel.

13. A method according to claim 11 and wherein said second metal comprises at least one of tin and a tin alloy.

14. A method according to claim 12 and wherein said second metal comprises at least one of tin and a tin alloy.

15. A method according to claim 11 and wherein said first melting temperature is in the range of 400 to 3400° C.

16. A method according to claim 11 and wherein said second melting temperature is in the range of 60 to 500° C.

17. A method according to claim 12 and wherein said second melting temperature is in the range of 80 to 420° C.

18. A method according to claim 11 and wherein said plastic material comprises a plastic material having a processing temperature which lies between said first melting temperature and said second melting temperature.

19. A method according to claim 11 and wherein said article is an extruded article.

20. A method according to claim 12 and wherein said article is an extruded article.

21. Apparatus for producing a conductive plastic article comprising:
a solid mass former receiving a multiplicity of fibers of a first metal having a first melting point and forming a solid mass of said multiplicity of fibers of said first metal together with a second metal having a second melting point less than said first melting point;
a mixer, combining plastic material with said solid mass;
a heater, heating said plastic material with said solid mass to a temperature above said second melting point but less than said first melting point, whereby said multiplicity of fibers are at least partially released from said solid mass and are conductively joined together by said second metal; and
an article former, forming said conductive plastic article from said heated plastic material and cooling said conductive plastic article wherein when cooled, said multiplicity of fibers are conductively joined at least partially by said second metal.

22. Apparatus according to claim 21 and wherein said first metal comprises AISI 302 stainless steel.

23. Apparatus according to claim 21 and wherein said second metal comprises at least one of tin and a tin alloy.

24. Apparatus according to claim 22 and wherein said second metal comprises at least one of tin and a tin alloy.

25. Apparatus according to claim 21 and wherein said first melting temperature is in the range of 400 to 3400° C.

26. Apparatus according to claim 21 and wherein said second melting temperature is in the range of 60 to 500° C.

27. Apparatus according to claim 22 and wherein said second melting temperature is in the range of 80 to 420° C.

28. Apparatus according to claim 21 and wherein said plastic material comprises a plastic material having a processing temperature which lies between said first melting temperature and said second melting temperature.

29. Apparatus according to claim 21 and wherein said article is an extruded article.

30. Apparatus according to claim 22 and wherein said article is an extruded article.

31. A conductive article comprising:
a multiplicity of metal fibers, said fibers being formed from a first metal having a first melting temperature; and
globules of a second metal having a second melting temperature, lower than said first melting temperature, conductively at least partially joining said fibers thus creating an electrically conductive network.

32. A conductive article according to claim 31 and wherein said first metal is selected from a set of stainless steel alloys consisting of: type AISI 302; type AISI 306L; and type AISI 347.

33. A conductive article according to claim 31 and wherein said second metal comprises at least one of tin and a tin alloy.

34. A conductive article according to claim 32 and wherein said second metal comprises at least one of tin and a tin alloy.

35. A conductive article according to claim 31 and wherein said first melting temperature is in the range of 400 to 3400° C.

36. A conductive article according to claim 31 and wherein said second melting temperature is in the range of 60 to 500° C.

37. A conductive article according to claim 32 and wherein said second melting temperature is in the range of 80 to 420° C.
